(19) United States
(12) Patent Application Publication
(10) Pub. No.: US 2025/0141906 A1
(43) Pub. Date: May 1, 2025

(54) NETWORK INTRUSION BASED INTELLIGENT REPLICATION OF MICROSERVICES IN A MULTI CLOUD SERVICE MESH

(71) Applicant: International Business Machines Corporation, Armonk, NY (US)

(72) Inventors: Sudheesh S. Kairali, Kozhikode (IN); Satyam Jakkula, BENGALURU (IN); Sudhanshu Sekher Sar, Bangalore (IN); MADHURI MADHAVAN PILLAI, BANGALORE (IN); Sarbajit K. Rakshit, Kolkata (IN)

(21) Appl. No.: 18/385,104

(22) Filed: Oct. 30, 2023

(51) Int. Cl. H04L 9/40

(52) U.S. Cl. CPC H04L 63/1433; H04L 63/1416; H04L 63/1466

(57) ABSTRACT

A network intrusion prevention and protection deployment method, system, and computer program product for providing security in a multi-cloud service mesh, the computer-implemented method including selectively deploying, via an instruction from an administrator, a network intrusion prevention and protection tool in a multi-cloud service mesh.

### BACKGROUND

The present invention relates generally to a network intrusion prevention and protection deployment method, and more particularly, but not by way of limitation, to a system, method, and computer program product for preventing intrusion/suspicious activities in a network by identifying and routing user profiles involved in intrusion or suspicious activities to prevention clusters.

In any application landscape, multiple microservices are present with different functionalities. And, in this case, microservices are having upstream and downstream relationships. To execute a business workflow, multiple microservices are to be used as per the sequence of business functionalities to be executed. For example, to process an entire insurance process, multiple microservices are to be involved in a workflow.

Multi-cluster service mesh is an existing architecture. Conventionally, multi-cluster deployments provide a greater degree of isolation and availability, but increase complexity. If the systems have high availability requirements, then clusters are likely required across multiple zones and regions. One can achieve staged (e.g., canary) configuration changes or new binary releases in a single cluster, where the configuration changes only affect a small amount of user traffic. Additionally, if a cluster has a problem, then one can temporarily route traffic to nearby clusters until one address the issue.

### SUMMARY

In view of the problems in the art, the inventors have considered a technical solution that categorizes the clusters where all of the clusters may need detection capabilities, but the selecting deployment enabled by the invention herein allows an administrator to choose to select few clusters with prevention capabilities. Thereby, the technical solution disclosed herein improves the technology as well as provides the practical application of a cost-efficient deployment of Network Intrusion Detection and Prevention Systems (NIDPS).

And, the invention further provides the technical solution to the technical problem that, once a user profile is identified as having been involved in intrusion or suspicious activities, the invention can route such a user to the prevention clusters so that cost may not exponentially increase.

In an exemplary embodiment, the present invention can provide a computer-implemented method for providing security in a multi-cloud service mesh, the computer-implemented method including selectively deploying, via an instruction from an administrator, a network intrusion prevention and protection tool in a multi-cloud service mesh.

In another exemplary embodiment, the present invention can provide a network intrusion prevention and protection deployment computer program product for providing security in a multi-cloud service mesh, the network intrusion prevention and protection deployment computer program product comprising a computer-readable storage medium having program instructions embodied therewith, the program instructions executable by a computer to cause the computer to perform: selectively deploying, via an instruction from an administrator, a network intrusion prevention and protection tool in a multi-cloud service mesh.

In another exemplary embodiment, the present invention can provide a network intrusion prevention and protection deployment system for providing security in a multi-cloud service mesh, the network intrusion prevention and protection deployment system including a processor and a memory, the memory storing instructions to cause the processor to perform selectively deploying, via an instruction from an administrator, a network intrusion prevention and protection tool in a multi-cloud service mesh.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings.

Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes (and others) of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 depicts a computing environment 100 according to an embodiment of the present invention;

FIG. 2 exemplarily shows a high-level flow chart for a network intrusion prevention and protection deployment method 200 according to an embodiment of the present invention;

FIG. 3 exemplarily depicts a deployment of an NIDPS 300 on a service mesh with multiple clusters according to an embodiment of the present invention;

FIG. 4 exemplarily depicts a deployment of an NIDPS 400 in a prevention mode on the service mesh with multiple clusters according to an embodiment of the present invention; and

FIG. 5 exemplarily depicts a deployment of an NIDPS 500 in a lazy mode on the service mesh with multiple clusters according to an embodiment of the present invention.

### DETAILED DESCRIPTION

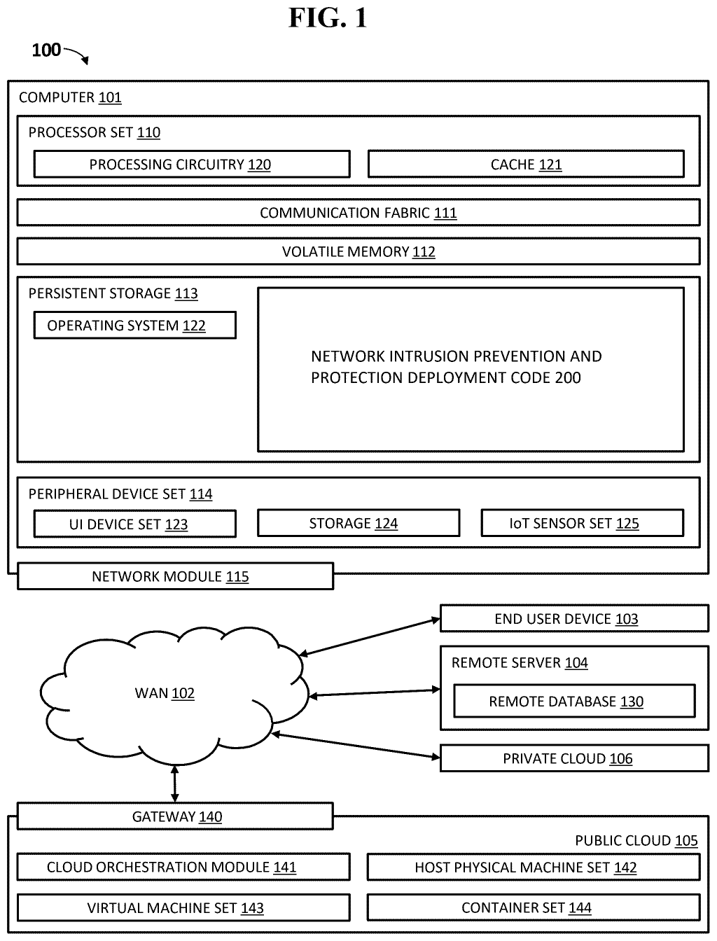

The invention will now be described with reference to FIGS. 1-5, in which like reference numerals refer to like parts throughout. It is emphasized that, according to common practice, the various features of the drawing are not necessarily to scale. On the contrary, the dimensions of the various features can be arbitrarily expanded or reduced for clarity.

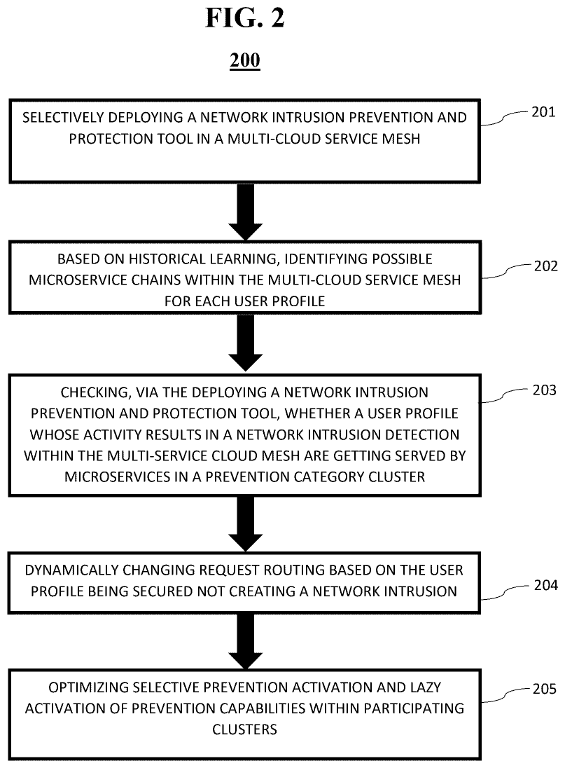

With reference now to the exemplary method 200 depicted in FIG. 2, the invention may include various steps to allow an administrator to selectively deploy network intrusion prevention and protection mechanisms selectively in a multi-cloud service mesh. The control plane will be aware of all the clusters with prevention capability.

In every system, there may be activities by bad/illegitimate users—especially if it is publicly accessible. Most of the clients of a capability-exposed via service mesh arch may be legitimate. But, illegitimate users may impact user experience and security of these users by network intrusion Denial of Service (“DOSing”), etc.

Conventionally, Network Intrusion Detection and Prevention Systems (NIDPS) to prevent network intrusion are deployed. The conventional NIDPS are resource-intensive and may slow down traffic for legitimate users as well. Also, when deployed in a multi-cloud service mesh (e.g., “cluster 1” and “cluster 2”), an administrator might need to deploy costly and performance intensive NIDPS capabilities in all the clusters. This will considerably increase the cost of deployment even though there may be mostly legitimate users which are actually not involved in any suspicious activities.

Therefore, the conventional techniques have the problem that NIDPS cost will increase based on a number of clusters involved in a service mesh even though a user count of illegitimate users may not be exponentially increasing.

The network intrusion prevention and protection deployment method 200 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems generally recognized as cognitive (i.e., humans).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is noted that M1->M2->M3->M4-> . . . >MN is a microservice chain in which an illegitimate user is participating (where N is an integer numbering the microservice). All are in “V1” version.

With reference generally to FIGS. 1-5, based on historical learning, the inventive technique described herein identifies possible microservice chains for each user profile. Based on historical learning of user-specific information, the invention can identify the users whose activities result in network intrusion detection within the service mesh.

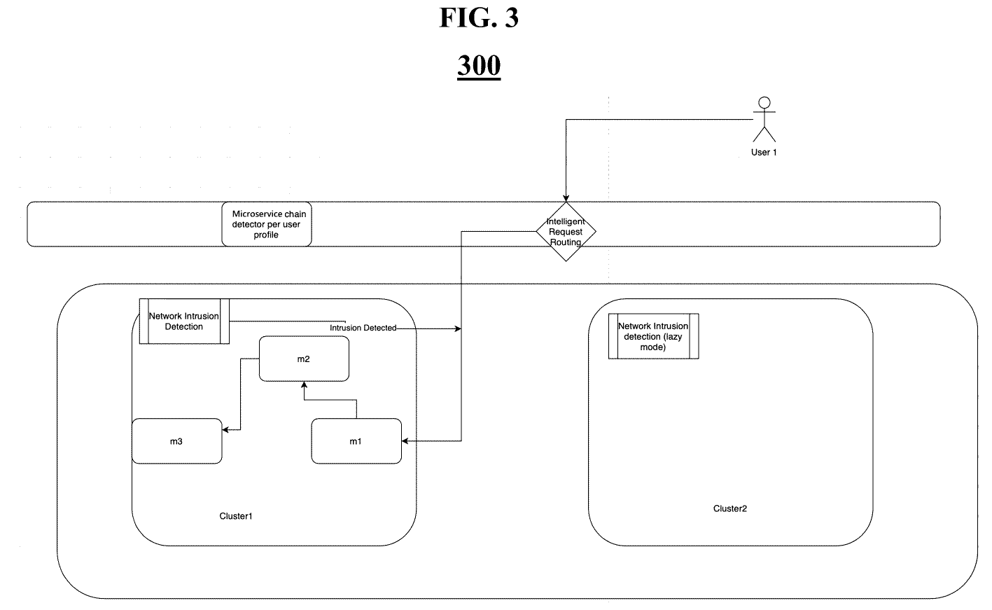

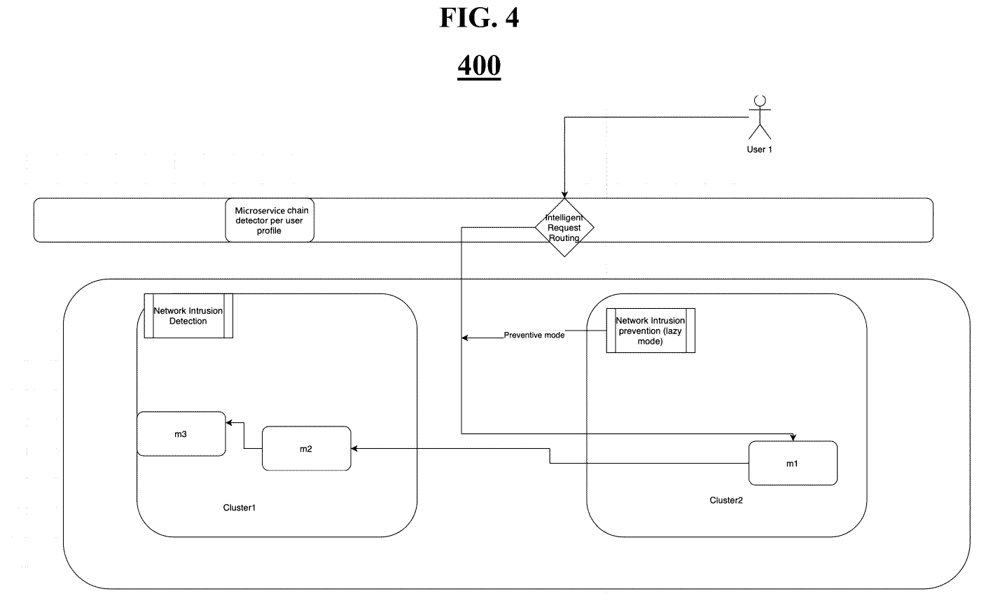

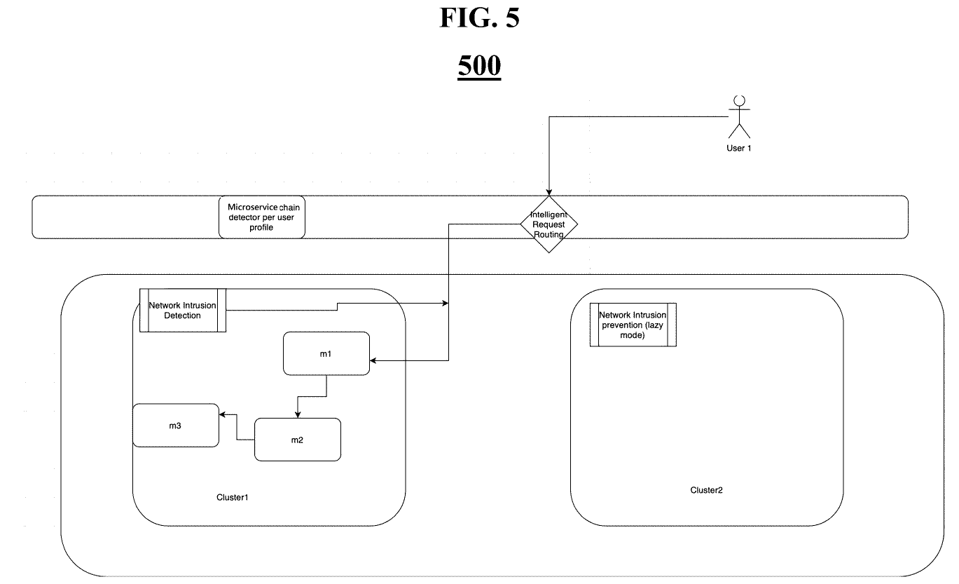

And, service meshes 300, 400, and 500 are depicted in FIGS. 3-5. FIG. 3 depicts the clusters before lazy prevention activation. FIG. 4 depicts the clusters after lazy prevention activation. FIG. 5 depicts clusters going back to an original state once threats are over.

The invention can check whether the users are getting served by microservices in a prevention category cluster. If not, then the invention can auto-create temporary secured chains in a prevention category cluster for such user profiles and route requests of such users to the secured chain. Secured chains will have NIDPS protection at the beginning and each microservices involved.

And, the invention can also perform a partial deployment as well such as M1, M2 in a prevention cluster and M3 in a detection cluster—in cases in which the intrusion activities are detected in M1 and M2 specifically (e.g., see deployment 400 in FIG. 4). That is, the invention may perform partial deployments in the prevention cluster upon detecting cases of intrusion activities.

Also, if the users which are being secured are not creating further issues (i.e., network intrusion, etc.), such users may be moved back to the original chain and clusters by the invention dynamically changing request routing. If a secured chain does not have at least one active user profile, then the secured chain may be deleted by service mesh from a prevention cluster.

The invention can further optimize selective prevention(s) activations and lazy activations of prevention capabilities within participating clusters.

Thereby, the invention provides a cost-effective method to protect a network for cloud customers.

It is further noted that the invention may be implemented in a multi-cloud service mesh-based architecture such as Istio or the like. But, the invention is not limited to be implemented on Istio or the like. Istio is an open platform-independent service mesh that provides traffic management, policy enforcement, and telemetry collection. Istio is developed fully in the open on GitHub.

With specific reference to FIG. 2, in step 201, a network intrusion prevention and protection tool (referred to also hereinafter as “tool”) may be selectively deployed in a multi-cloud service mesh. In one embodiment, the selective deployment is determined by a user with administrative access (i.e., an administrator) to the multi-cloud service mesh. Also, a control plane (e.g., the control plane of Istio) is aware of all the clusters with prevention capability.

The control plane takes a desired configuration, and its view of the services, and dynamically programs the proxy servers, updating them as the rules or the environment changes. The service mesh control plane may be extended, and it will be able to detect all of the microservice chains that a particular user profile is participating in.

Regarding the network intrusion prevention and protection tool, exemplary tools such as SNORT® may be integrated to service mesh and could then monitor all the Proxy-to-Proxy communications. SNORT® is an open-source intrusion detection system (IDS) and intrusion prevention system (IPS) that provides real-time network traffic analysis and data packet logging. SNORT® uses a rule-based language that combines anomaly, protocol, and signature inspection methods to detect potentially malicious activity. Although SNORT® is provided as an example of the tool, other tools can be utilized, and the invention is not limited to SNORT®. For example, Suricata can be used (e.g., see https://suricata.io).

More specifically, in step 201, when a new cluster is added to a multi-cloud service mesh, the administrator may be able to select which of the cluster(s) are in prevention mode and which one(s) is in detection mode. The tool may deploy all the replicas of the microservices initially in a detection mode cluster. As soon as a single threat is detected, the user profile associated with the threat is extracted and the microservice chain is also identified.

In step 202, based on historical learning, the tool may identify possible microservice chains within the multi-service cloud mesh for each user profile. That is, based on historical learning of user-specific information, the tool may identify the users whose activity(ies) results in network intrusion detection within the service mesh.

For example, all the microservices which are participating are replicated to a specific compartment/namespace which is secured in a prevention mode cluster. The chain is replicated only from the microservice in which the intrusion is detected. The newly deployed microservices will be identified as a new secured version by the service mesh.

For example, M1->M2->M3->M4 is a microservice chain in which an illegitimate user is participating. All microservices are in a V1 version. At M3, an intrusion event is detected for “User 1”. So, M1->M2->M3 is replicated to a secured compartment and the service mesh identifies this as a V1 Secured version.

It is noted that M1->M2->M3->M4-> . . . >MN is a microservice chain in which an illegitimate user is participating (where N is an integer numbering the microservice). All are in “V1” version.

In step 203, the tool checks whether a user profile whose activity results in a network intrusion detection within the multi-service cloud mesh are getting served by microservices in a prevention category cluster. If not, then the invention will auto-create temporary secured chains in a prevention category cluster for such user profiles and route requests of such users to the secured chain. Secured chains will have NIDPS protect at the beginning and each microservices involved.

By deploying the tool, the service mesh will automatically set request routing rules for “User 1” so that the traffic from “User 1” will always go to M1->M2->M3 (V1 Secured chain).

In step 204, if the users which are being secured are not creating further issues (i.e., network intrusion, etc.), then such users may be moved back to the original chain and clusters by dynamically changing request routing. If a secured chain does not have at least one active user, then the profile secured chain may be deleted by the service mesh from a prevention cluster.

In other words, secured users (i.e., those not creating intrusion activities) are moved to secured original chain clusters.

In one embodiment, the tool can be deployed as a partial deployment such as M1 in prevention cluster and M2 and M3 in a detection cluster—in cases of the intrusion activities detected in M2 and M3 specifically such as depicted in the service mesh 400 of FIG. 4.

In step 205, selective prevention activations and lazy activations of prevention capabilities within participating clusters may be optimized.

That is, the tool may also do a lazy deployment of prevention mode clusters as it is not initially required (e.g., such as shown in FIGS. 3-5).

Specifically, for the optimization of selective prevention activations, the invention may selectively activate prevention capabilities in selected few detection clusters if opted by an administrator. The invention may do so in such a manner that a Replication effort is less (e.g., less movement of microservices). For example, M1->M2->M4->M5 is a chain which is to be secured. M1->M2->M3 are in cluster 1 and M4->M5 are in cluster 2. Then, cluster 1 could be converted to a prevention mode cluster so that M1->M2. Thereby, the chain is secure and an entry point is secured (e.g., as depicted in FIGS. 3-4).

The invention will keep monitoring such secured microservice chains. If there are no illegitimate activities from “User 1” for a period of time (e.g., say 30 mins—configurable), then the microservice chain is removed and request routing rules also are removed. Therefore, the invention may go back to the configuration of 500 in FIG. 5.

That is, FIG. 5 exemplarily shows the movement of the microservices back to detection clusters when threats are over. Technically, configurations are the same as those shown in FIG. 3.

Thereby, the method 200 allows an administrator to selectively deploy network intrusion prevention and protection tools selectively in a multi-cloud service mesh, perform historical learning for identifying possible microservice chains for each user profile whose activities result in network intrusion detection within the service mesh, check microservices served by user profiles in a prevention category cluster and auto-creating temporarily secured chains in the prevention category cluster for user profiles and routing requests of such users to the secured chain, performing partial deployments in the prevention cluster upon detecting cases of intrusion activities, and move secured users (e.g., those not creating intrusion activities) to secured original chain clusters.

### Exemplary Aspects, Using a Computing Environment

With reference now to FIG. 1, computing environment 100 contains an example of an environment for the execution of at least some of the computer code involved in performing the inventive methods, such as network intrusion prevention and protection deployment code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented method for providing security in a multi-cloud service mesh, the computer-implemented method comprising:
selectively deploying, via an instruction from an administrator, a network intrusion prevention and protection tool in a multi-cloud service mesh.

2. The computer-implemented method of claim 1, further comprising performing historical learning for identifying microservice chains for each user profile whose activities result in a network intrusion detection within the multi-cloud service mesh.

3. The computer-implemented method of claim 1, further comprising:
checking microservices served by user profiles in a prevention category cluster;
auto-creating temporarily secured chains in the prevention category cluster for the user profiles; and
routing requests of such users to one of the secured chains.

4. The computer-implemented method of claim 2, further comprising:
checking microservices served by the user profiles in a prevention category cluster;
auto-creating temporarily secured chains in the prevention category cluster for the user profiles; and
routing requests of such users to one of the secured chains.

5. The computer-implemented method of claim 1, further comprising performing a partial deployment of the network intrusion prevention and protection tool such that at least one microservice is deployed in a prevention cluster and at least one microservice is deployed in a detection cluster.

6. The computer-implemented method of claim 1, further comprising dynamically changing a request routing to move a user back to an original location of the multi-cloud service mesh based on an absence of detection of a network intrusion by the user after the network intrusion prevention and protection tool is deployed.

7. The computer-implemented method of claim 1, further comprising optimizing selective prevention activations and lazy activations of prevention capabilities within participating clusters of the multi-cloud service mesh.

8. The computer-implemented method of claim 1, wherein a control plane accessible by the administrator is aware of all clusters within the multi-cloud service mesh with prevention capabilities.

9. The computer-implemented network intrusion prevention and protection deployment method of claim 1, embodied in a cloud-computing environment.

10. A network intrusion prevention and protection deployment computer program product for providing security in a multi-cloud service mesh, the network intrusion prevention and protection deployment computer program product comprising a computer-readable storage medium having program instructions embodied therewith, the program instructions executable by a computer to cause the computer to perform:
selectively deploying, via an instruction from an administrator, a network intrusion prevention and protection tool in a multi-cloud service mesh.

11. The network intrusion prevention and protection deployment computer program product of claim 10, further comprising performing historical learning for identifying microservice chains for each user profile whose activities result in a network intrusion detection within the multi-cloud service mesh.

12. The network intrusion prevention and protection deployment computer program product of claim 10, further comprising:
checking microservices served by user profiles in a prevention category cluster;
auto-creating temporarily secured chains in the prevention category cluster for the user profiles; and
routing requests of such users to one of the secured chains.

13. The network intrusion prevention and protection deployment computer program product of claim 11, further comprising:
checking microservices served by the user profiles in a prevention category cluster;
auto-creating temporarily secured chains in the prevention category cluster for the user profiles; and
routing requests of such users to one of the secured chains.

14. The network intrusion prevention and protection deployment computer program product of claim 10, further comprising performing a partial deployment of the network intrusion prevention and protection tool such that at least one microservice is deployed in a prevention cluster and at least one microservice is deployed in a detection cluster.

15. The network intrusion prevention and protection deployment computer program product of claim 10, further comprising dynamically changing a request routing to move a user back to an original location of the multi-cloud service mesh based on an absence of detection of a network intrusion by the user after the network intrusion prevention and protection tool is deployed.

16. The network intrusion prevention and protection deployment computer program product of claim 10, further comprising optimizing selective prevention activations and lazy activations of prevention capabilities within participating clusters of the multi-cloud service mesh.

17. The network intrusion prevention and protection deployment computer program product of claim 10, wherein a control plane accessible by the administrator is aware of all clusters within the multi-cloud service mesh with prevention capabilities.

18. A network intrusion prevention and protection deployment system for providing security in a multi-cloud service mesh, the network intrusion prevention and protection deployment system comprising:
a processor; and
a memory, the memory storing instructions to cause the processor to perform:
selectively deploying, via an instruction from an administrator, a network intrusion prevention and protection tool in a multi-cloud service mesh.

19. The network intrusion prevention and protection deployment system of claim 18, further comprising performing historical learning for identifying microservice chains for each user profile whose activities result in a network intrusion detection within the multi-cloud service mesh.

20. The network intrusion prevention and protection deployment system of claim 18, embodied in a cloud-computing environment.
